(19) United States
(12) Patent Application Publication
(10) Pub. No.: US 2014/0047512 A1
(43) Pub. Date: Feb. 13, 2014

(54) SYSTEM AND METHOD FOR MONITORING ONLINE ACTIVITY ON ELECTRONIC DEVICES

(71) Applicant: Ariff SIDI, Lake Balboa, CA (US)

(72) Inventor: Ariff SIDI, Lake Balboa, CA (US)

(21) Appl. No.: 13/956,791

(22) Filed: Aug. 1, 2013

Related U.S. Application Data
(60) Provisional application No. 61/678,778, filed on Aug. 2, 2012.
(60) Provisional application No. 61/794,984, filed on Mar. 15, 2013.

(51) Int. Cl. G06F 21/31

(52) U.S. Cl. CPC G06F 21/31
USPC 726/4

(57) ABSTRACT

A system and method of monitoring one or more electronic devices is disclosed which allows the application developer and the first user to collaborate to create monitoring filters to monitor and control the electronic device(s). The monitoring system is able to monitor. The monitoring system further includes a system which allows communication amongst the application developer, first user(s) and/or second user(s).

### RELATED APPLICATIONS

This application claims priority to U.S. Provisional Application 61/678,778, entitled “SYSTEM AND METHOD FOR PROVIDING APPLICATION CONTROLS ACROSS A DIVERSITY OF APPLICATIONS,” filed Aug. 2, 2012, and U.S. Provisional Application 61/794,984, entitled “SYSTEM AND METHOD FOR MONITORING ONLINE ACTIVITY ON ELECTRONIC DEVICES,” filed Mar. 15, 2013, both of which are herein incorporated by reference in their entirety.

### TECHNICAL FIELD

The present disclosure relates to a system and method for monitoring and controlling online activity on various electronic devices and the applications on those devices. The present disclosure also relates a system and method for monitoring activity of electronic devices associated with a person.

### BACKGROUND

Technology is transforming entertainment, social media and education for children. In fact, it is believed that 51% of kids use two or more platforms to go online. That 53% of children have their own cellphone and/or smartphone and that 70% want a tablet to be their next purchase. It is evident that the increased use of mobile devices and other internet connected platforms (e.g. games consoles) by children will result in the increased need to monitor the child's activity on each of the devices that is used. Some of the prior art discloses technology that acts as a security measure at a single device and fails to properly tether a number of electronic devices and applications on those devices.

A number of products have attempted to address the issue of monitoring a person's activities, e.g. children, on computers and/or mobile devices. For example, many companies like Net Nanny (www.netnanny.com), provide a computer software program which requires the program to be download on each computer that will be monitored. So, users need to take the time to investigate the various devices that need to be monitored and then download the software unto the device. As is evident, such a process is both laborious and inefficient. Additionally, the majority of these existing solutions are effective only on traditional personal computers, rely heavily on certain capabilities of personal computers not available on other internet connected platforms, and are mainly effective for filtering web browsing. They are less capable or incapable of providing monitoring of common usage on other platforms.

U.S. Pat. Publication 2010/0121744 discloses a system and method for by which real-time monitoring and communication of usage data is conducted between a set of N numbered of devices where N is and integer. According to an embodiment, a communication network provides a common core architecture in which the devices connected to the system are converged regardless of their access network requirements or functional capacity. The system has the capacity to monitor and analyze all the usage information of each device connected to the system in regards to content, identity, type, quality, quantity, time, status, activity level, and metadata associated with the functions and applications utilized on a device. The analysis is further based on information governing a subscriber's devices, preferences, and features held in a subscriber database integrated within the system. The analyzed usage data is further processed through a variety of applications in order to generate a response, such as; a report, an alarm, or tailored options for interacting with the generating device which is deliverable in any format within the capacity of the receiving device including all multimedia aspects and non-multimedia aspects. The system further communicates the response in real-time to any device within the set as designated by the subscriber. In another aspect of the invention, the analyzed usage data can be stored for on demand requests of a communication response from past analysis. Furthermore, there is not a means that allows the user to communicate with the applications developers in constructing a desired filtering system that is desired by the user.

### BRIEF DESCRIPTION OF THE DRAWINGS

FIG. 1 illustrates a system showing an exemplary monitoring system for computing devices.

FIG. 2 illustrates an exemplary UI for the application developer to add or edit control parameters.

FIG. 3 illustrates an UI wherein the application developer would add a category of a new control parameter(s).

FIG. 4 illustrates an exemplary UI for how a monitored application would be associated with a first user (i.e. parent) account.

FIG. 5 depicts how a user may locate the devices and applications that are monitored and set up his/her monitoring and control preferences.

### SUMMARY OF THE INVENTION

Details of one or more implementations of the subject matter described in this specification are set forth in the accompanying drawings and the description below. Other features, aspects, and advantages will become apparent from the description, the drawings, and the claims.

In an embodiment, a monitoring system is disclosed which allows the first party to communicate with the developers on the desires/needs of the first party. The first user is able to communicate their needs through the monitoring system. The system would also be able to track the various requests made by the various first users to provide statistics and algorithms on the frequency and mean of category of requests.

In another embodiment, a monitoring system and method is disclosed which allows a first party to monitor two or more electronic devices through the web.

In another embodiment, a monitoring system and method is disclosed which allows input by both the first party and application developer to be used to be entered into the GUI which includes the desired monitoring criteria/filters. The system allows two way communication between the first party and application developer so a comprehensive monitoring system may be designed based on input by both parties. In yet another embodiment, the system further allows a second user to communicate with the first user.

In another embodiment, the monitoring system and method provides detailed information about each devices and each application located on each devices. This allows the first party to properly monitor both the devices and the applications in an orderly manner.

Another advantage is that the monitoring system facilitates creation and storage of software developer accounts and first party users accounts. The monitoring system provides a means to define and store control parameters for software developers and the means for the first party user(s) to customize the control parameters.

### DETAILED DESCRIPTION OF SPECIFIC EMBODIMENTS

Specific, non-limiting embodiments will now be described with reference to the drawings. Nothing in this description is intended to imply that any particular feature, component or step is essential. The patent application will use the term “electronic device” to include, amongst other things: computers, mobile device (iPhone, blackberry, etc.), mobile devices which are part of an automobile, laptops, notepads, tablets (e.g. iPad), gaming stations (e.g. Wii, PlayStation, etc.), televisions with ability to connect to the web, cable boxes, etc. Software applications are software programs developed to run on electronic devices. Software Applications may include such software, but not limited to: Facebook, Yelp, Calendar, Skype, Games, etc. that are used by the public.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” and “an” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

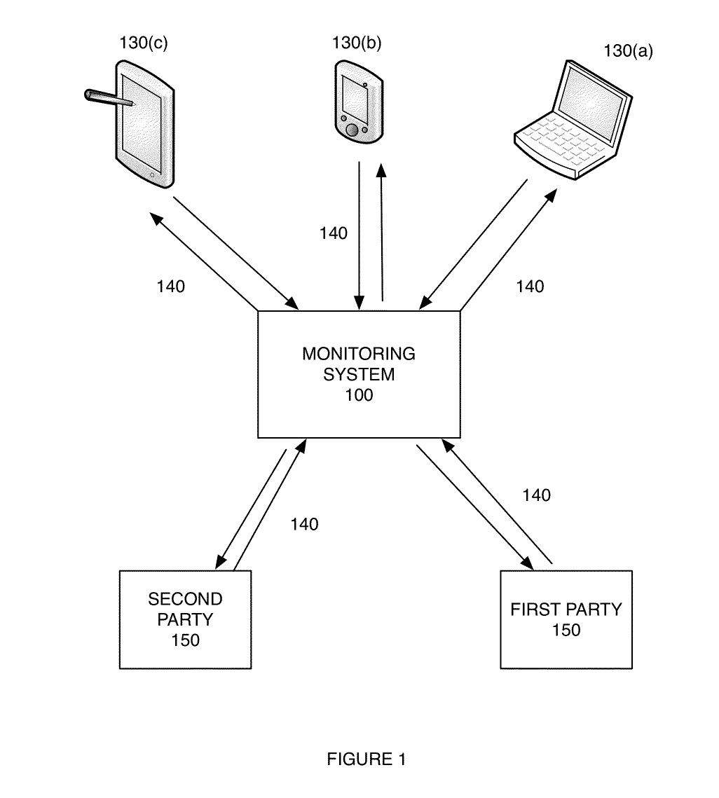

FIG. 1 illustrates an embodiment, amongst many embodiments, which depicts a monitoring system 100 for electronic devices. It should be appreciated that the monitoring system 100 may be implemented on a server, implemented on the various devices and/or any combination. As shown in FIG. 1, the monitoring system 100 communicates, via the internet 140, with the first party module 110, second party module(s) 130 (a, b, and c) and the developer module 150. It should be appreciated that the terms “first user” and “superior user” will be used interchangeably. It should also be appreciated that the terms “second user” and “subordinate user” will be used interchangeably. In an exemplary embodiment the monitoring system 100 would also have cloud-based component which would store the information on a cloud platform that would be accessible through the internet at any time. In the one embodiment, the monitoring system 100 would be part of the operating system of the electronic device 130. For example, the monitoring system 100 could be part of an iPhone's IOS system which would automatically be loaded and running whenever the electronic device was on and enabled. In another embodiment, the electronic system would not be a part of the operating system of the electronic device 130 and instead would be enabled through each of the applications running on the device(s). In this embodiment, the applications on the electronic devices would be “paired” with the first party module 110 of the monitoring system 100. In yet another embodiment, the monitoring system 100 may be downloaded onto the device to be monitored (but not a part of the OS).

The monitoring system is able to communicate with a plurality of application developers and/or their software applications. The monitoring system 100 may also communicate with a plurality devices associated with a first user used to monitor software applications for a plurality of second users. Furthermore, the monitoring system 100 may communicate with a plurality of electronic devices which are associated with the software applications for the plurality of second users. For example, the monitoring system 100 may communicate with a number of software developers (e.g. Facebook, Yelp) and a plurality of first users (Parent #1, Parent #2) to monitor a plurality of second users' (Child #1, Child #2) account for the software developers. The monitoring system 100 is able to obtain information about the control parameters that are offered or might be offered from each software developer(s) for their software that is associated with each second user. This allows a parent to log into their account on the monitoring system 100 and be provided a list of all of the authenticated software application associated with the second user and the specific parameters associated with each software application. The monitoring system provides the first users the means to retrieve and view usage activity information from device(s) and application(s) linked to their account. The system further allows the first users to organize linked devices/applications into folder-like structures based on common characteristics.

It should be appreciated that in one embodiment, the first user is a parent monitoring their child's electronic devices and the applications on those devices through the web-based monitoring system 100 and receiving alerts. However, the system could be used by other parties to monitor various electronic devices. The system monitors a number of applications located on various electronic devices associated with their child (or second party).

FIG. 1 also illustrates exemplary embodiment which the monitoring system 100 is in communication with first party module 110, developer module 150 and the various electronic devices 130a, 130b and 130c. It should be appreciated that the communication between the monitoring system 100 and the parties may be a two way communication. As discussed above, the electronic device may comprise of one or more devices which the first party 110 wishes to monitor. The monitoring system would generally receive setup information from the developer on how they would like the GUI configured that would be presented to the first party. The monitoring system 100 would be able to provide information from the first party, analytics and data about the devices being monitored, metrics used for calculating revenue sharing information and other information that would be helpful to the application developer. The monitoring system is also able to provide general analytics about all the devices monitored by the monitoring system (i.e. your child uses this app more than 65% of other children). One of the advantages of the present invention, amongst other advantages, is that the monitoring system is able to collect data about a plurality of users, plurality of web developers, plurality of software applications and a plurality of first users. Therefore, the system is able to create various outputs using the data to allow the users to optimize use of the monitoring system. Other examples include, but are not limited to: (a) providing the list of the most commonly offered control parameters amongst the developers and/or on the software applications; (b) provide a list of the most commonly occurring problems that first users are tracking; (c) the hours during which the first user(s) activity increases or likely to have suspicious activity; and (d) sending alerts whenever any of the software applications that are associated with the second users has a new monitoring feature.

The first party module 110 would be able to also conduct two-way communications with the monitoring system 100. For example, the first party could provide set up controls, filtering/monitoring criteria and other information that needs to be conveyed to the developer module 150 and/or electronic devices 130a, 130b, and 130c. Furthermore, the monitoring system is able to send information about the devices and applications that are being monitored to the first party preferably, and even the application developer(s). The monitoring system 100 could also allow two-way communication between parent and child (regarding settings, messaging, etc.).

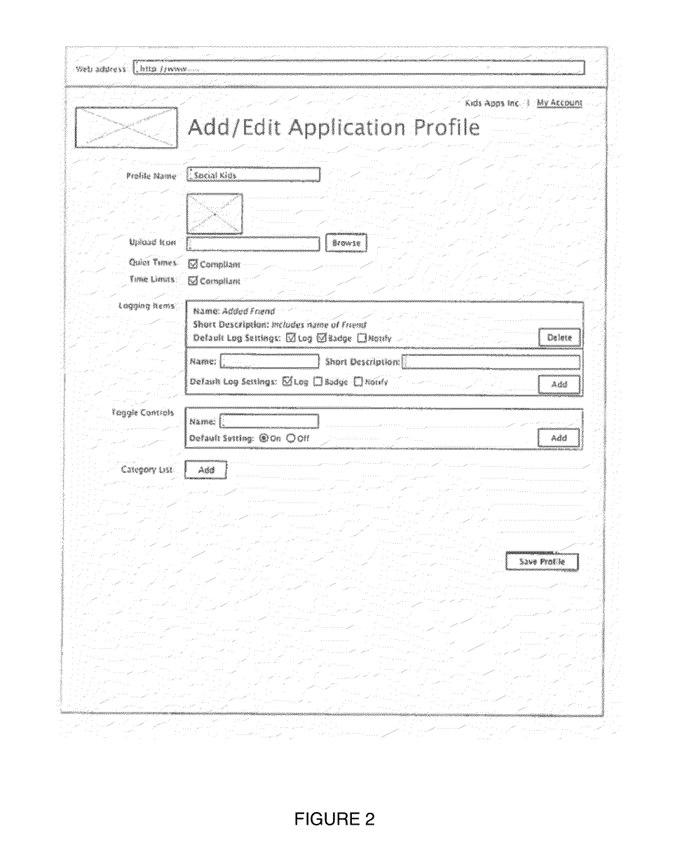

FIG. 2 illustrates an exemplary user interface presented to the application developer. This user interface allows the application developer to communicate with the first party about the various control parameters that is/are available on the software application. The terms “control parameter” is used to refer to any type of setting, filter, trigger, toggle or other activity which would either case the developer to block data access, block access to the application, block access to a portion of the application, send an alert, and/or configure behaviors in a device or application. In the exemplary embodiment in FIG. 2, the UI provides a form that allows the developer to describe the various control parameters that are available. The application developer may either add a description of a new parameter to be displayed to the first party, edit a preexisting parameter, or select a predefined parameter. The UI would generally allow the application developer to configure the look of the UI that will be shared with the first party. The application developer is able to provide a profile name (e.g. company or application name), upload a logo which will be also located on the UI and describe the various parameters (blocking the ability for “added friend”) that will be available.

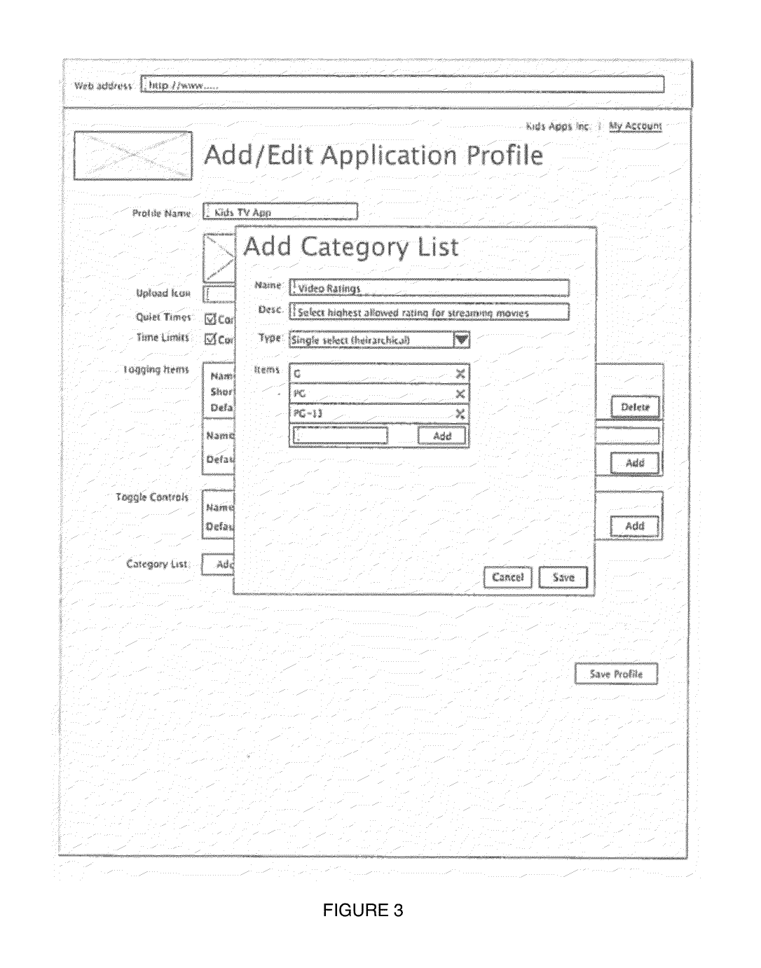

As shown in FIG. 3, the application developer would add an instance of a new control parameter. This allows the application developer to add a new parameter and the type of monitoring (e.g. blocking access, sending alerts, etc.). As an example, FIG. 3 depicts an instance where the application developer has decided to create a list title “Video Ratings” and a description of the parameter. The parameters could also have rankings.

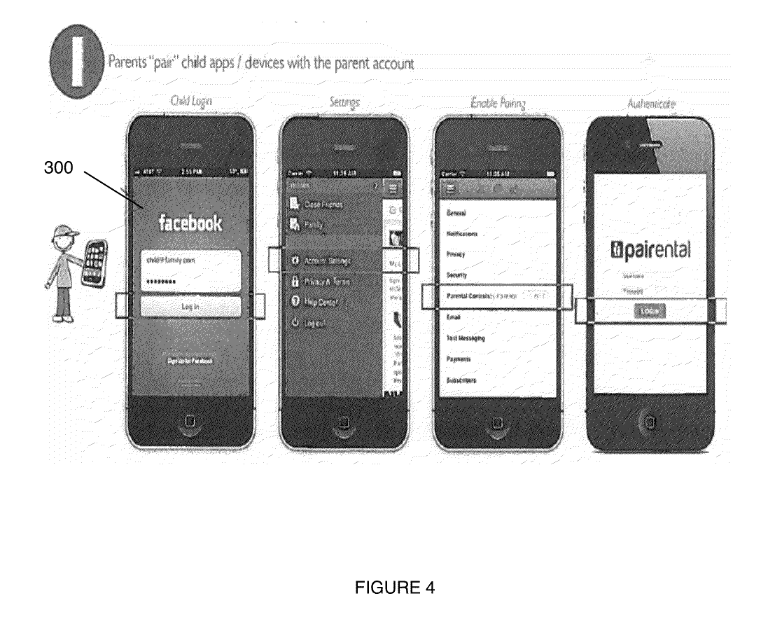

FIG. 4 depicts how the application 300 on a device is paired with the first party module on the monitoring system. It should be noted that the first party user would only be able to communicate with application developers and exert control over devices and applications that are registered with the monitoring system. The application 300 or device that would be monitored would need to be opened and logged when appropriate. Then the user would access the setting/account setting 310 and enable the monitoring system to communicate with the application of each software application that is available. The user would then authenticate themselves with the monitoring system and finalize the new connection between the application and the monitoring system. For purposes of organization, the monitoring system could either attempt to locate information about the device through the electronic system, require a person to enter in the information, provide the user with a list of options from which to select, or do nothing. Similarly, the monitoring system could attempt to gain information about the user of the device or application being monitored. For example, if a parent logs into their son's iPhone Facebook account and enables the monitoring system to be run through application's settings (e.g. Facebook), the system would then have the parent enter in their monitoring system's account and authenticating the application, device, etc. So the parents could then enter that “Son's Facebook” application on “Son's iPhone” has been authenticated. It should be appreciated the monitoring system could then monitor all the devices which the son is using his Facebook account. One of the advantages of the present invention is that in an exemplary embodiment the person being monitored (e.g. child) and the person doing the monitoring would be agreeing on the devices and applications to be monitored. So, if the child were to later decide to “disable” the monitoring system 100, the monitoring system would send an alert out to the first party that an application(s) and/or device(s) have now been disabled.

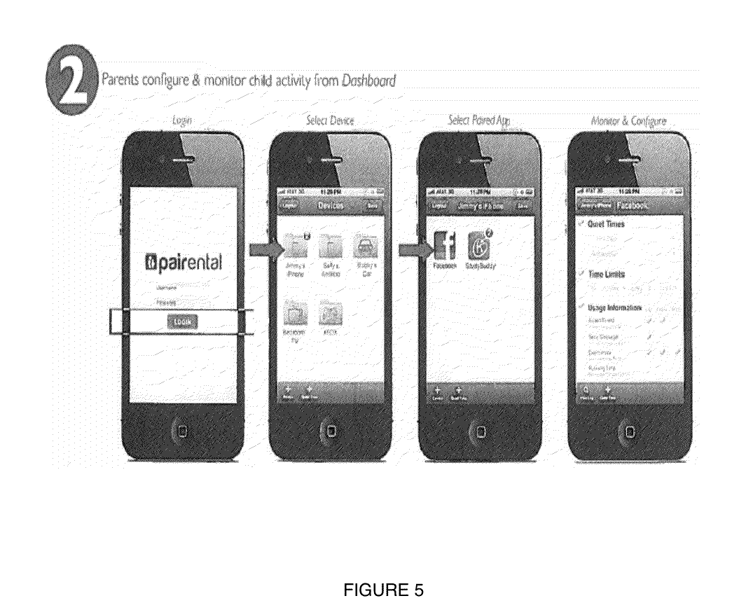

FIG. 5 depicts how a user may locate the devices and applications that are monitored and sets up his/her monitoring criteria. As shown in FIG. 5, once the user logs onto the system, the user would then be provided with a list of all of the electronic devices 130a, 130b, 130c, 130d and 130e. The user may then select an electronic device, e.g. Jimmy's iPhone, and then would have a displayed all of the applications that are being monitored, e.g. Facebook and StudyBuddy. If the user then clicks on one the application that they would like to monitor and/or change monitoring criteria, then the user is provided a GUI as shown in 450. It should be appreciated that the monitoring system could also organize by each second user which is being monitored.

FIG. 5 depicts an exemplary embodiment of the GUI which allows the user to set the monitoring criteria. The GUI could be configured to show the application that is being monitored and its specific configuration. So that each GUI is configured based on input from both the first party and the application developer. As appreciated to one skilled in the art, FIG. 5 shows some of the monitoring criteria/filters that may be used, but is not meant to be an exhaustive list. As an example, FIG. 5 shows a GUI which the user may set preferences on the filters for Quiet Time (when the application may not be accessed), Time limits (limit the amount of time the application is used in a day, week, month, etc . . . ), Log Items (to check on new notifications on the application, e.g. new friends). The system may include a number of other monitoring criteria, amongst others, including: (a) an anti-bullying detecting module: this module would look for both words and patterns in communications between parties to detect potential bullying. (b) a comprehensive report: this report would entail details about online activity on each application and each mobile device. It would also include chart(s) to show patterns and to detect anomalies. (c) a conditional monitoring module that would check for various words (e.g. bad words, name of specific people, etc . . . ), photos and/or videos that are not appropriate (e.g. the system may find photos and/or videos which contain PG-13 or R rated content and have the ability to block any content that the user wishes to block. It should be appreciated that the monitoring system 100 may take a number of remediation actions depending on the predefined set of rules provided by the first party. For example, the remediation action may comprise of blocking data, blocking access to the entire application, blocking access to portions of the application, blocking content on the application and/or sending alerts to the first user.

FIG. 2a could also be used to show an exemplary embodiment where the first party adds a “category” of activity that they would like to have monitored. It should also be appreciated that this GUI may also be used so that the user and the developer of the application can communicate with one another to either add or change the various monitoring criteria. The alerts could be based on a number of various indicators: toggle (on or off), ranges (from 5 p.m.-10 p.m.), match criteria (if word=fight), pattern detection (number of minutes user has been connected, ranking (if G rated yes, if P 17 only yes after approval; if R then NO). The system allows the user to submit this information to the application developer (e.g. FaceBook) and have the application develop determine whether this is a feature they are able and/or willing to provide. As shown in FIG. 6, the first user may request that a “Video Ratings” filter be added and provide some type of ranking system (e.g. G, PG and PG-13) This also allows the application developer to get feedback and input from the user of areas that they are interested in monitoring. The system could also provide report to the developer on various statistics on the users. For example: the system could provide statistics of the type of filters users have requested so that the developer could focus the filters with the greatest demand, the types of filters on other applications, the ability to communicate with first party user, e.g. parent who is monitoring the child.

As way of example, a description will be provided on how the application developer uses the monitoring system. Generally, the developer will create an account on the monitoring system. Once the developer has created an account the developer may then log onto the monitoring system. The developer would then be provided with the option to setup a new application profile. The developer may then provide a name for the profile and also upload an icon, e.g. a trademark of the company. The developer may then select and/or customize 1 or more controls from a predefined set of control behaviors. For example, the developer wants to share with the first user when the second user has added a friend, so he/she adds a “Log Item” behavior to the profile, gives it a custom name of “Added Friend” and optionally a short description to display to first users in the dashboard. Another example includes an instance when the developer provides the first user the ability to turn video playback on/off, so he/she adds a “toggle” behavior to the profile, gives it a custom name of “Video Allowed” and optionally a short description. The developer would then save the profile and would receive a unique “profile key” from the monitoring system that the developer will embed into his/her software to help enable the process of later linking the application with the monitoring system. The developer programs his/her application to allow the first users to sign in to their service account. This one-time sign in process uses the “profile key” and the first user credentials to make an association between the “Application Profile” and the first user account thereby enabling the first user to remotely set their preferred configuration of controls identified by the profile. As application runs, if it has been linked to a first user account it requests the first user's preferred configuration from the monitoring system and acts accordingly. Additionally, the monitoring system can request the first user's “general preferences” not specifically configured for the application's profile but that represents more global first user preferences and acts on them accordingly if relevant. It should be noted that the current monitoring system allows the first party and the second party to also communicate with one another via the monitoring system. The second user could request temporary/permanent permission for particular activities that are being blocked by the first party. By way of example, a child (second party) who has been blocked from accessing videos on Facebook by the parent (first party), could send an electronic request via the monitoring system to the parent to request permission to Facebook. The electronic message would be routed to the parent for their approval. Upon approval by the parent, the monitoring system would then automatically inform the relevant software developer, i.e. Facebook, about the change in the control parameters.

As an example, a description will be provided on how the first user would interact with the monitoring system. Initially, the first user would create an account; the first user optionally configures “general preferences” that all linked applications can request from the monitoring system and use if relevant; the first user gains access to second user's application; the first user uses application feature to sign in to their account on monitoring system (one time); the first user can relinquish access to child's application; the first user signs in to the monitoring system (via internet or through the electronic device); the first user is presented a list of applications linked to their account; the first user selects a linked application; and/or the first user can choose to review activity log or customize application's configuration based on controls defined by the “Application Profile”. It should be appreciated that the steps above may be performed in a different order and/or some step(s) may be eliminated.

All of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located, and may be cloud-based devices that are assigned dynamically to particular tasks. The results of the disclosed methods and tasks may be persistently stored by transforming physical storage devices, such as solid state memory chips and/or magnetic disks, into a different state.

The methods and processes described above may be embodied in, and fully automated via, software code modules executed by one or more general purpose computers. Some or all of the methods may alternatively be embodied in specialized computer hardware. Code modules or any type of data may be stored on any type of non-transitory computer-readable medium, such as physical computer storage including hard drives, solid state memory, random access memory (RAM), read only memory (ROM), optical disc, volatile or non-volatile storage, combinations of the same and/or the like. The methods and modules (or data) may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed methods may be stored in any type of non-transitory computer data repository, relational databases and flat file systems that use magnetic disk storage and/or solid state RAM. Some or all of the components shown in FIG. 1, may be implemented in a cloud computing system.

Further, certain implementations of the functionality of the present disclosure are sufficiently mathematically, computationally, or technically complex that application-specific hardware or one or more physical computing devices (utilizing appropriate executable instructions) may be necessary to perform the functionality, for example, due to the volume or complexity of the calculations involved or to provide results substantially in real-time.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer product or packaged into multiple computer products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The various elements, features and processes described herein may be used independently of one another, or may be combined in various ways. All possible combinations and subcombinations are intended to fall within the scope of this disclosure. Further, nothing in the foregoing description is intended to imply that any particular feature, element, component, characteristic, step, module, method, process, task, or block is necessary or indispensable. The example systems and components described herein may be configured differently than described. For example, elements or components may be added to, removed from, or rearranged compared to the disclosed examples.

All of the processes and process steps described above (including those of FIG. 2) may be embodied in, and fully automated via, software code modules executed by one or more general purpose computers, servers, or other types of computing machines. The code modules may be stored on any type of non-transitory computer-readable medium or other computer storage system or device. Some or all of the methods or steps may alternatively be embodied in specialized computer hardware. The results of the disclosed methods and tasks may be persistently stored by transforming physical storage devices, such as solid state memory chips and/or magnetic disks, into a different state.

The foregoing description is intended to illustrate, and not limit, the inventive subject matter. The scope of protection is defined by the claims. In the following claims, any reference characters are provided for convenience of description only, and do not imply that the associated steps must be performed in a particular order.

What is claimed is:

1. A method of monitoring and controlling the activities of a plurality of software applications associated with one or more electronic devices, comprising:
Receiving control parameters associated a plurality of software applications;
providing a user interface to a first user to select one or more of the control parameters associated with the plurality of software applications to monitor the electronic device;
Receiving authentication from the electronic device to authorize monitoring of the plurality of software applications on the electronic device based on the selected one or more of the control parameters; and
Providing a user interface to view one or more results associated with the monitoring of the plurality of software applications on the electronic device.

2. The method of claim 1, wherein the first party is a parent and the electronic device and the plurality of software applications are associated with a child of the parent.

3. The method of claim 1, wherein the electronic device is a video game console.

4. The method of claim 1, wherein the authentication from the electronic device is received via an Internet application on the electronic device.

5. The method of claim 1, wherein the authentication from the electronic device is received via a native operating system application on the electronic device.

6. The method of claim 1, further comprising automatically monitoring, after receiving the authentication, a second device based on the selected one or more control parameters.

7. The method of claim 1, wherein the plurality of software applications are associated with one application developer.

8. The method of claim 1, further comprising automatically monitoring, after receiving the authentication, a second device based on the selected one or more control parameters.

9. The method of claim 1, further comprising providing the user interface to the first party to select one or more of the control parameters associated with the plurality of software applications to monitor a second electronic device.

10. The method of claim 12, wherein the selected one or more of the control parameters associated with the plurality of software applications to monitor the second electronic device are different than the selected one or more of the control parameters associated with the plurality of software applications to monitor the electronic device.

11. The method of claim 13, further comprising the providing the user interface to view one or more results associated with the monitoring of the electronic device and the second device.

12. The method of claim 1, wherein receiving authentication from the electronic device comprises receiving authentication to authorize monitoring a subset of the plurality of software applications on the electronic device based on the selected one or more of the control parameters.

13. The method of claim 15, wherein the providing an user interface to view one or more results comprises providing the user interface to view one or more results associated with the monitoring the subset of the plurality of applications on the electronic device.

14. The method of claim 1, wherein the results comprising usage statistics associated with the electronic device;

15. The method of claim 1, further comprising providing an user interface to enable the first party to request disabling monitoring of the electronic device.

16. The method of claim 1, wherein at least one of the control parameters comprise parameter to block data access;

17. The method of claim 1, wherein at least one of the control parameters comprise parameter to block access to a portion of an application;

18. The method of claim 1, wherein at least one of the control parameters comprise parameter to send an alert;

19. The method of claim 1, wherein the plurality of software applications are associated with a plurality of application developers.
